(19) United States
(12) Patent Application Publication
(10) Pub. No.: US 2021/0019673 A1
(43) Pub. Date: Jan. 21, 2021

(54) MULTI-DIMENSIONAL RISK MATRIX AND METHOD FOR GENERATING THEREOF

(71) Applicant: GSIL Co,.Ltd., Seongnam-si (KR)

(72) Inventors: Jung Woo LEE, Seoul (KR); Yong Suk KANG, Seongnam-si (KR)

(73) Assignee: GSIL Co,.Ltd., Seongnam-si, (KR)

(21) Appl. No.: 16/909,386

(22) Filed: Jun. 23, 2020

(30) Foreign Application Priority Data
Jul. 16, 2019 (KR) 10-2019-0085683

(51) Int. Cl. G06Q 10/06; G06F 17/18

(52) U.S. Cl. CPC G06Q 10/0635; G06F 17/18; G06Q 10/06398; G06Q 10/063114

(57) ABSTRACT

The present invention relates to a multi-dimensional risk matrix and a method of generating the same, which can support to associate comprehensive risk determination, evaluation, and follow-up supports from the aspect of activity, environment, and worker on the basis of past statistical data, calculate an actual risk of a corresponding activity by independently analyzing and calculating risks of activity, environment, and worker that may have a major influence on a construction work, increase practical utilization by reflecting actual evaluation of a manager, and reflect special factors to additionally review individual factors that can be ignored in statistically analyzed general factors.

### CROSS-REFERENCE TO RELATED APPLICATIONS

This application is based on and claims priority from Korean Patent Application No. 10-2019-0085683, filed on Jul. 16, 2019 with the Korean Intellectual Property Office, the disclosure of which is incorporated herein in its entirety by reference.

### BACKGROUND OF THE INVENTION

### Field of the Invention

The present invention relates to a multi-dimensional risk matrix and a method of generating the same, which can support to associate comprehensive risk determination, evaluation, and follow-up supports from the aspect of activity, environment, and worker on the basis of past statistical data.

### Background of the Related Art

In relation to construction safety management, risk management using a checklist is most widely used in the construction field since it is easy to understand and simple to use. Particularly, domestic and foreign construction companies have started to create basic checklists with interest in risks from the past and have developed the checklists steadily, and presently, each company manages risks with elaborately established checklists. However, as existing risk management methods using a checklist put emphasis on convenience, management items are greatly simplified, and are focused on determining existence of risk rather than evaluating a risk level. Therefore, since the existing risk management methods are difficult to select core risk factors and diversity of the management methods is insufficient, there is a limitation in providing a practically valuable risk management method or risk resolution method.

### SUMMARY OF THE INVENTION

Therefore, the present invention has been made in view of the above problems, and it is an object of the present invention to provide a multi-dimensional risk matrix and a method of generating the same, which can calculate an actual risk of a corresponding activity by independently analyzing and calculating risks of activity, environment, and worker that may have a major influence on a construction work, increase practical utilization by reflecting actual evaluation of a manager, and reflect special factors to additionally review individual factors that can be ignored in statistically analyzed general factors.

To accomplish the above object, according to one aspect of the present invention, there is provided a multi-dimensional risk matrix generation method for performing comprehensive risk management and evaluation on a construction activity, an external environment, and an activity participation worker, the method comprising: a step of calculating activity risk evaluation information through a facility factor evaluation step of evaluating facility factors by reflecting information on facilities deployed in the activity according to selection of a construction type, an activity, and a workplace in which the activity is progressed, an activity PI calculation step of calculating a probability (P) of occurrence of a safety accident for each activity step and an impact (I) according to occurrence of the accident by reflecting the facility factors and previously collected general activity factors, and an activity significance (S) reflecting step of additionally reflecting an activity significance (S) reflecting previously collected special activity factors in a PI result value of the activity PI calculation step; a step of calculating environmental risk evaluation information through an environmental PI calculation step of calculating a probability (P) of occurrence of a safety accident and an impact (I) according to occurrence of the accident by reflecting previously collected general environmental factors according to selection of the construction type, the activity, and the workplace in which the activity is progressed, and an environmental significance (S) reflecting step of additionally reflecting an environmental significance (S) reflecting previously collected special environmental factors in a PI result value of the environmental PI calculation step; and a step of calculating worker risk evaluation information through a worker PI calculation step of calculating a probability (P) of occurrence of a safety accident and an impact (I) according to occurrence of the accident by reflecting previously collected general worker factors according to selection of the construction type, the activity, and the workplace in which the activity is progressed, a worker competency evaluation step of calculating a competency index by evaluating competency of a worker deployed in the activity, and a worker significance (S) reflecting step of additionally reflecting a worker significance (S) reflecting the competency index and previously collected special worker factors in a PI result value of the environmental PI calculation step, wherein the activity risk evaluation information, the environmental risk evaluation information, and the worker risk evaluation information are drawn in three dimensions.

### BRIEF DESCRIPTION OF THE DRAWINGS

FIG. 1 is a flowchart illustrating a method of generating a multi-dimensional risk matrix according to an embodiment of the present invention.

FIG. 2A is a flowchart illustrating a method of generating an activity risk matrix according to an embodiment of the present invention. FIG. 2B is an exemplary view showing activity PI values according to an embodiment of the present invention as a two-dimensional graph, and FIG. 2C is an exemplary view showing a three-dimensional activity risk matrix according to an embodiment of the present invention.

FIG. 3A is a flowchart illustrating a method of generating an environmental risk matrix according to an embodiment of the present invention. FIG. 3B is an exemplary view showing environmental PI values according to an embodiment of the present invention as a two-dimensional graph, and FIG. 3C is an exemplary view showing a three-dimensional environmental risk matrix according to an embodiment of the present invention.

FIG. 4A is a flowchart illustrating a method of generating a worker risk matrix according to an embodiment of the present invention. FIG. 4B is an exemplary view showing worker PI values according to an embodiment of the present invention as a two-dimensional graph, and FIG. 4C is an exemplary view showing a three-dimensional worker risk matrix according to an embodiment of the present invention.

FIG. 5 is a flowchart illustrating the organizational competency evaluation step of FIG. 4A in detail.

FIGS. 6 and 7 are views showing a multi-dimensional risk matrix according to another embodiment of the present invention.

### DETAILED DESCRIPTION OF THE PREFERRED EMBODIMENT

Hereafter, the present invention will be described with reference to the accompanying drawings.

The terms used herein are used only to describe a specific embodiment and not intended to limit the present invention. Singular expressions include plural expressions unless the context clearly indicates otherwise. It should be understood that in this specification, terms such as “include” and “have” are intended to indicate existence of features, numbers, steps, operations, components, parts, or combination thereof described in the specification, and the possibility of existence or addition of one or more other features, numbers, steps, operations, components, parts or combinations thereof are not excluded in advance.

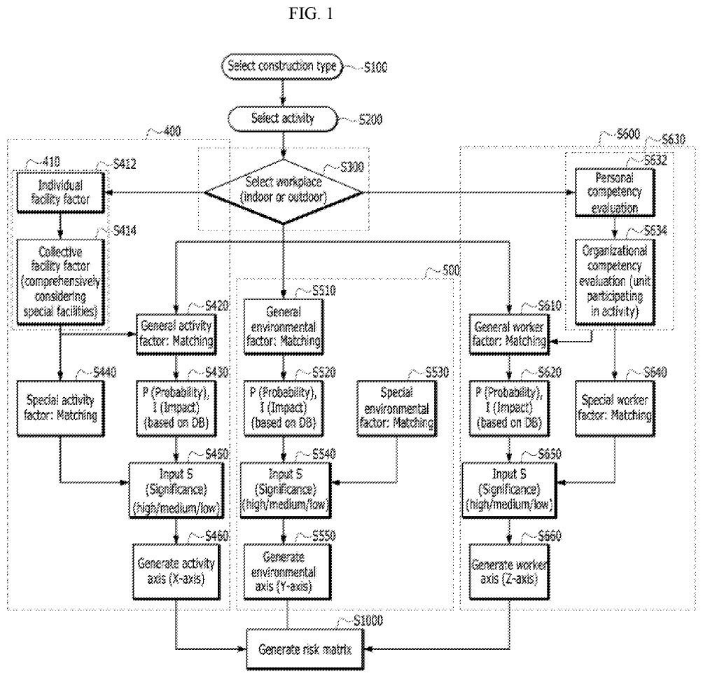

Referring to FIG. 1, a multi-dimensional risk matrix generation method according to an embodiment of the present invention for performing comprehensive risk management and evaluation on a construction activity, an external environment, and a worker participating in the activity may include a step of selecting a construction type (S100), a step of selecting an activity (S200), a step of selecting a workplace classified as indoor or outdoor (S300), a step of calculating activity risk evaluation information (S400), a step of calculating environmental risk evaluation information (S500), and a step of calculating worker risk evaluation information (S600).

At this point, the “construction type” refers to a type and items of a construction, and the “activity” refers to an individual construction process (progress) corresponding to each individual construction type.

The “risk” according to the present invention refers to risks such as loss of life and/or property that may occur due to procedural errors in the procedure of a construction work according to the facilities intrinsically inherent in a construction type or activity, i.e., deployed in the construction type and activity, internal and external environmental factors of a construction site, working time conditions, working types and the like, task execution errors that may occur in a construction work process, such as workers, facilities and the like deployed in the construction type and activity, and/or failures in meeting activity preconditions needed for stable execution of the current construction type or activity.

The “risk” according to the present invention may be digitized (quantified) as a score within a scale range of “1 to 10”, or may be generated or expressed as a grade such as “high-medium-low”.

The “matrix” according to the present invention may refer to a matrix that is visualized (i.e., for example, by calculating a risk of an “activity” as past, present, and future prediction values (numerical values), respectively, and converting the values in the form of a three-dimensional vector or a three-dimensional graph) on the basis of a risk value (numerical value) based on past statistical analysis results according to the factors of each activity, environment, and worker, a real-time risk value (numerical value) based on analysis of data collected through a sensor network (and/or a current risk value (numerical value) that is an arbitrary value assigned by a site manager or the like by evaluating the risk on the basis of historical data) constructed in a construction site, and a risk value (numerical value) according to future prediction based on a prediction algorithm (Monte Carlo simulation or the like).

In addition, unlike the above description, the “matrix” according to the present invention may be defined in various forms and shapes, such as a three-dimensional matrix comprehensively visualizing activity (X-axis), environment (Y-axis) and worker (Z-axis) or a multi-dimensional (such as two-dimensional) graph.

In addition, unlike the above descriptions, the “matrix” according to the present invention may refer to image data generated in the form of multi-dimensional, i.e., two-dimensional or three-dimensional, graphs, coordinates, diagrams or the like on the basis of past risk values, current risk values, and future risk values (numerical values, numbers) by combining any two factors of activity, environment, and worker.

A construction type for managing risk may be selected at step S100, and an activity, which is a detailed progress according to the construction type, may be selected at step S200.

In addition, according to an embodiment of the present invention, step S100 and/or step S200 may include the step of assigning a specific sequence code to each construction type and activity sequentially or according to a predetermined priority. In addition, step S100 and/or step S200 may further include a step of receiving an input or a transfer of data, such as a detailed name of a construction work, a name of a person/worker in charge of the construction work, a detailed schedule of the construction work, materials provided in the construction work, detailed specifications of the construction work, CAD or three-dimensional building information modeling (BIM) of the construction work, and information on construction cost of each construction type and activity, construction work activities, and the like from the outside, storing and utilizing the data for calculation or processing.

Next, step S300 is a step of selecting a workplace as indoor or outdoor, and the workplace is selected to reflect information on comprehensive environmental conditions that may affect the activity.

The activity is greatly affected by external environmental factors such as temperature, rainfall, wind speed, wind direction and the like depending on whether the workplace is indoors or outdoors, and step S300 is a step taking into account the point that the risk is also changed according thereto.

Therefore, through step S300, the site manager or the like may change, modify or adjust the risk value (numerical value) of each activity, environment and/or worker through a means such as lowering or excluding weighting values of internal and/or external environmental factors of a work site, in a situation in which the influence of rain, wind, or temperature is limited in an indoor environment (for example, inside a structure or a tunnel under construction) not or less affected by the external environment, and accordingly, additional risks that may occur depending on the external environment, not the risk of the activity itself, are limited.

Contrarily, in the case of an outdoor activity directly exposed to the outside, for example, during the rain, restrictions are generated in the work such as external painting or welding, and considering the point of increasing the possibility of generating a safety accident of a worker due to high temperature or the like, the site manager or the like may further reflect additional weighting value or importance of the internal and/or external environmental factors of the work site in a digitized (quantified) risk at step S300, as well as the risk of the construction type or activity themselves.

Through step S300 like this, a site manager and/or a remote manager may more previously and objectively grasp the risks that should be differently considered depending on the internal and external environmental conditions and site situation even in a construction work of the same construction type and activity, and therefore, further higher reliability may be assigned to the multi-dimensional risk matrix.

Next, step S400 is a step of calculating activity risk evaluation information by generating an activity risk matrix for performing risk management and evaluation for a construction activity, and may include a facility factor evaluation step (S410), a general activity factor matching step (S420), an activity PI calculation step (S430), a special activity factor matching step (S440), an activity significance (S) reflecting step (S450), and an activity axis generation step (S460).

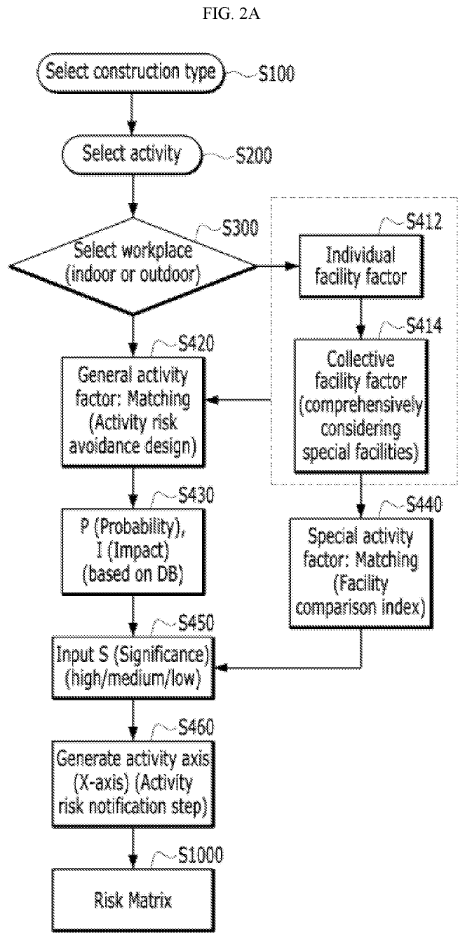

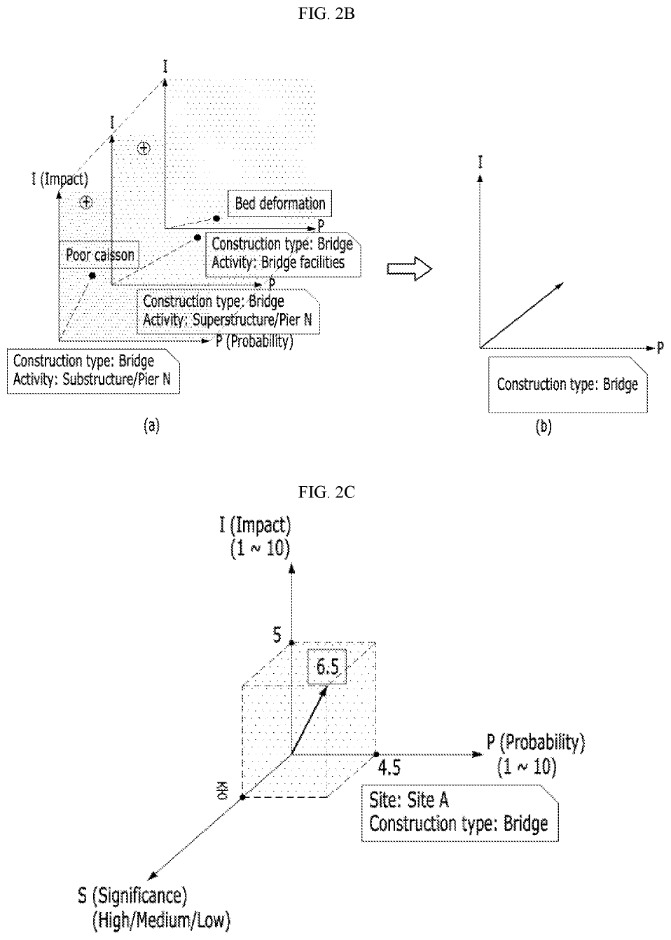

Here, step S400 will be described in detail with further reference to FIG. 2A.

Specifically, at step S410, facility factors may be evaluated for the facilities deployed in the activity selected at step S200.

Here, step S410 may be performed by reflecting the data generated at the individual facility factor evaluation step (S412) of evaluating individual facility factors by reflecting information on individual facilities deployed in an activity, and the collective facility factor evaluation step (S414) of evaluating collective facility factors by comprehensively reflecting information on a collective facility configured of a plurality of facilities. That is, an average data on individual facilities and/or collective facilities deployed in the past construction type and activity the same as or similar to the current construction type and activity (generally, years of use, inspection state and the like of the facilities deployed in the same or similar activities, which will be described below) may be reflected, and the past statistical data like this may be utilized thereafter in determining an activity significance (S) by reflecting the state of individual/collective facilities that are deployed currently.

At the individual facility factor evaluation step (S412), construction equipment (excavators, bulldozers, tower cranes, loaders, forklifts, scrapers, dump trucks, etc.) suitable for the characteristic and situation of corresponding construction type, activity and (indoor and outdoor) workplace and the construction progress situation may be automatically or selectively reflected after the steps of selecting a construction type (S100), selecting an activity (S200), and selecting a workplace (S300) are sequentially progressed. In addition, on the basis of statistical data or the like related to construction site accidents according to operation of various construction equipment in the past, the individual facility factor evaluation step (S412) may receive incident and accident information that can be generated by individual construction equipment at a construction site, such as average accident occurrence issues of each construction equipment type, i.e., an accident occurrence type of construction equipment (e.g., collapse of an upper structure such as a telescopic cage or the like of a tower crane, breakage of a jib, dropping of a material, etc.), a frequency, the number of accidents occurred by the equipment during a set period and an accumulated number of the accidents, standard years of use, and durability of each major component and the like, and risk information according thereto from its own DB or the outside.

The collective facility factor evaluation step (S414) is a step capable of reflecting increase or decrease of risk through mutual impact between the individual construction equipment reflected at the individual facility factor evaluation step (S412). That is, the collective facility factor evaluation step (S414) is a step capable of reflecting additional risks that may occur according to the operating (rotating) range of individual construction equipment, major moving lines of the individual construction equipment moving in the construction site, placement of second construction equipment (e.g., movement or parking of other tower cranes on the horizontal surface, or dump trucks or other construction equipment under the second construction equipment on the horizontal plane) within the working radius of first construction equipment (e.g., a tower crane), a relation of mutual influence according to movement and/or operation, and/or operation, movement or the like of the first construction equipment with respect to the neighboring second construction equipment within a set region (range), after the steps of selecting a construction type (S100), selecting an activity (S200), and selecting a workplace (S300) are sequentially performed. That is, the collective facility factor evaluation step (S414) may categorize accident occurrence issues generated by contact or collision between construction equipment, turnover accidents or the like in the site by the incident and accident information, on the basis of statistical data or the like related to construction site accidents according to operation of various construction equipment in the past, and may receive risk information according thereto from its own DB or the outside.

In other words, the individual facility factor evaluation step (S412) is a step capable of receiving a transfer and/or an input of risks based on past statistical data on individual construction equipment reflected according to selection of a construction type, an activity, and a workplace, and the factor evaluation step (S414) may be regarded as a step of receiving a transfer and/or an input of risks of human accident and property accident that may occur while one or more pieces of construction equipment operate and/or move within a set range (the construction site) by reflecting installation locations and/or major moving lines of individual facilities in the construction site, which are derived through the individual facility factor evaluation step (S412), on the basis of past statistical data.

Next, risk information of an activity according to selection of a construction type, an activity, and a workplace may be generated and/or received at step S420, and facility factors (information generated through steps S412 and/or S414) may also be reflected as an option.

Here, the general activity factor matching step (S420) may take into account information on the property of the performance task itself of each individual activity, past accident history, and categorized as indoor or outdoor accidents of each construction type and activity collected according to the construction type, activity, and workplace. Categorized as indoor or outdoor human/property accidents of each construction type and activity may be past statistical data according to the standardized construction types defined by the KOSHA Code (Korea Occupational Safety and Health Agency, Guidelines for the Construction of Safety and Health Management System) or the Standard Specification for Building Construction (DB, for example, Korea Occupational Safety and Health Agency, Cases and Countermeasures for Major Construction Accidents), or may be based on the data already secured or currently being continued to be monitored and updated by construction companies, local governments, and central governments.

However, the general activity factors may be collected at the general activity factor matching step (S420) according to the present invention, in addition to the past statistical data, by additionally reflecting data on the occurrence of construction accidents, which are caused by the property of the activity itself occurring at various domestic and foreign construction sites in real time, and causes and damages of the accidents through a wired/wireless communication network (in the case of tunnel excavation, it refers to the risks included in each individual activity or an individual construction itself included in a corresponding activity, such as an accident due to rock blasting, collapse due to tunnel excavation, and risk issues that may occur according to operation of equipment for tunnel excavation. This refers to external environmental issues, such as the properties of environment itself, i.e., weak states of rocks targeted for tunnel excavation, presence of groundwater, and risk issues related to the environment according to external weather information, and the like. In addition, the property of worker itself described below may be defined as a risk included in the risk issues caused by the body condition or the like of an individual worker or a unit, which is a group of individual workers, participating in an individual activity or construction work).

In addition, as described above, the general activity factor matching step (S420) may further include a step and process (“activity risk avoidance design step”) of presenting risk information included for each individual construction type and activity, and information on mitigating activities for risk avoidance and/or mitigation according to a selected construction type, activity and workplace, and therefore, a site manager may be supported to recognize in advance a risk of a construction site work to be progressed at present or in the near future and establish countermeasures in advance.

Next, step S430 is an activity PI calculation step, and may calculate the probability (P) of occurrence of a safety accident of each activity step and the impact (I) according to occurrence of the accidents by reflecting general activity factors. Here, the probability (P) and the impact (I) mean the probability (P) of a construction accident in a construction site and the intensity (I) of damage according to occurrence of the accident for evaluating risks, and the probability of accidents such as major disasters of each construction type and activity (human accident, etc.) and the amount of loss according to occurrence of the accidents for each construction type, activity, and workplace may be expressed numerically and financially.

The activity PI calculation step (S430) is based on statistical information related to past accidents occurred according to the construction type/activity and the state of the workplace, and may generate data of a PI result value on a multi-dimensional axis, such as two-dimensional axis or the like, by reflecting past accident statistical information of each selected individual activity.

As shown in FIG. 2B, the activity PI calculation step (S430) according to an embodiment of the present invention may derive the probability (P) of a past accident for detailed individual activities of each construction type and the impact (I, may be expressed in monetary figures) according to occurrence of the accident ((a) of FIG. 2B), and comprehensively calculate a PI value of each construction type and/or activity and detailed activity ((b) of FIG. 2B). In addition, the activity PI may also be calculated by integrating all construction types of each construction site (for example, the graph as shown (b) of FIG. 2B) for each construction type is generated for each construction type, and an activity PI according to all construction types of a corresponding construction site is calculated by overlapping or combining a plurality of graphs generated for each construction type).

In addition, unlike (also together with) this, the data of the activity PI result value described above may also be generated as a value digitized on a scale of 1 to 10 points.

Next, step S440 refers to a special activity factor matching step in which actually deployed facility factors are reflected according to the selected construction type and activity.

Special activity factors at the special activity factor matching step (S440) refer to the external environmental condition of a selected construction type and activity (reflecting workplace selection information), information on construction equipment actually deployed for each construction type, and conditions of corresponding construction equipment. For example, the special activity factors may correspond to whether a tower crane actually deployed in a corresponding construction site is registered as a construction machine, whether a safety inspection (regular and occasional inspection) has been performed, a time point and a cycle of inspection, a manufacturing year, a manufacturing and management operation company, accident history, installation (rising) of the tower crane, qualification and career/history information of disassembling workers (manufacturer technicians, scaffolding technicians, etc.), whether a tower crane pilot to be involved has a license and his or her experience/history, a state of the ground that is the grounding surface of the installed tower crane, and the like. That is, the special activity factor matching step (S440) may include a step of receiving an input of individual history of various construction equipment actually deployed in a construction site, and actual data on preliminary factors related to installation or the like that should be prepared in advance to progress a set work from a site manager or the like, or receiving, inputting, managing, and storing the history and data through various sensors or the like installed in the individual equipment.

That is, unlike the general activity factors generating intrinsic disaster occurrence information of construction equipment deployed according to the construction type and activity, and the construction type and activity itself based on past statistical data, the special activity factors (reflecting As-IS information) according to the present invention have a difference capable of collecting, reflecting and digitizing actual information, such as the state and maintenance state of construction equipment including tower cranes or the like actually deployed in a corresponding construction site, the current ground state of the construction site, the ground surface condition, the slope of the site, the condition of the surrounding area and the like.

In addition, the special activity factor matching step (S440) according to the present invention may generate a separate “facility comparison index” by relatively comparing information on the average years of use, safety inspection cycles, safety status and the like of individual construction equipment generally deployed according to the construction type, activity, and workplace confirmed through the individual facility factor matching step (S412) with the average years of use, safety inspection cycles, safety status and the like of individual construction equipment actually deployed in the site. The “facility comparison index” is presented as a numerical value or the like at the significance (S) input step (S450) described below so that a site manager or the like may utilize in increasing or decreasing the possibility of an accident risk of the actually deployed construction equipment or the risk of entire construction types, activities, and the like. For example, when tower cranes actually deployed in a corresponding construction site are produced recently in comparison with generally deployed tower cranes and their durability and safety are higher than those of the generally used existing tower cranes as the structure of the mast horizontal support where a cylinder support is fixed is further strengthened and reinforced, a relatively higher score is given to the “facility comparison index” generated at the special activity factor matching step (S440), and the score given in this way is presented at the significance (S) input step (S450) to support the site manager or the like to evaluate by further mitigating the possibility of occurrence of risks at the significance input step. The “facility comparison index” like this may be expressed in a scale unit of 1 to 10. When new construction equipment or the like having durability superior to that of previously used construction equipment is deployed, it may be used as one of executions of mitigating activities that can be derived at step S420.

In addition, the special activity factor matching step (S440) calculates the risk of each region/zone/area/range in an activity that reflects the correlation between the risk of an activity in a set region/zone/area/range (inspection of equipment used in a corresponding activity, evaluation of facility competency, etc.) and external environmental conditions, and may be used to calculate a real-time and/or predicted risk of each activity by reflecting current and/or future external environmental condition information. To this end, the “facility comparison index” may be additionally generated by relatively comparing an average value of occurrence of accidents (based on past data), such as arrangement and movement between construction equipment (facilities) according to operating conditions of a plurality of facilities generally deployed in each construction type and activity evaluated at the collective facility factor evaluation step (S414), and contact or the like on horizontal and vertical planes according to operation moving lines, with the possibility of occurrence of accidents, such as arrangement and movement between construction equipment deployed in a construction site, which is a target of actual evaluation, and contact or the like on the horizontal and vertical planes according to the operation moving lines (on the basis of data inputted by a site manager as it is, or transferred and received through a network of sensors attached to the individual equipment or disposed in the site). The “facility comparison index” like this is associated with virtual sensors or the like installed in the construction site, and additionally generates prediction information on the possibility of accidents, such as arrangement and movement, constraints on operation, and contact or the like of individual or collective construction equipment, according to external weather environments (wind speed, wind direction, outside temperature, humidity, rainfall, etc.) as an index for comparison (past-present-future) so that the index like this may be considered at the significance (S) input step (S450).

Next, step S450 refers to a significance (S, sensory level) input step in which a manager or the like may subjectively evaluate the risk of an individual activity itself at the current time point.

That is, at step S450, a site manager, a remote business manager or the like may input the activity significance (S) of the risk of an individual activity itself by relatively comparing and determining (“facility comparison index” and the like may also be used as evaluation data) past statistical data (PI value, derived through step S430) and current and/or future prediction data based on the special activity factors (S410). However, unlike the past statistical data (PI value, derived through step S430), which can be objectively digitized and derived, it is preferable to simplify the evaluation index at the significance (S) input step, considering the limitation of being subjectively evaluated by the site manager or the like, to reduce the error according to the subjective determination of the evaluator more than the evaluation index at step S430. For example, the evaluation index at step S430 has a wide evaluation range on a scale of 1 to 10, whereas at step S450, as the selection range that can be assigned for each evaluator is reduced by narrowing the evaluation range (interval) such as high/medium/low, possibility of generating an error according to the perspective of each evaluator can be minimized.

For example, the activity significance (S) may be graded only on a 3-score scale of high/medium/low, and a site manager or the like may evaluate the activity significance (S) on the 3-score scale of high/medium/low, and the activity significance (S) may be additionally reflected by being added to or subtracted from the PI result value derived at the activity PI calculation step S430.

In addition, in evaluating the activity significance (S), whether the mitigating activities derived and presented together at the general activity factor matching step (S420) are reflected in the construction site, which is an actual evaluation target, in the process of risk evaluation is also reflected at step S450, so that evaluation of the activity significance (S) of the site evaluator may be supported. That is, the activity significance (S) according to the present invention may be added to or subtracted from the PI result value considering ease of executing the mitigating activities described above, whether or not possessing execution assets and the like, and a three-dimensional matrix based on the PI and S values may also be generated together (or separately).

Next, step S460 is an activity axis generation step, and may generate an activity risk matrix. Here, the activity risk matrix may be generated by drawing the probability (P), the impact (I), and the activity significance (S) in three dimensions. In this activity risk matrix, vector values may be calculated as activity risk evaluation information.

In summary, at step S400, the risk of each activity itself is calculated by calculating the probability (P) and the impact (I) on the basis of the state of individual/collective construction equipment deployed in each construction type/activity and past data values related to the accidents of each activity, and at this time point, a manager or the like may derive an activity axis (X-axis) that has increased practical utilization by reflecting the psychological significance (S), which is practical information subjectively evaluating an actual state of an individual construction site, the current situation and state of individual/collective construction equipment, and the risk of an individual activity itself, and the risk of facilities (construction equipment) used in a corresponding activity. That is, in the present invention, the “significance” item that may include risk attributes other than the probability of an accident and the impact (amount of loss) is added considering the state of a workplace in a construction work of each construction type and activity, and the present invention is characterized in that a degree of intuitively and comprehensively sensing the importance of a risk by an evaluator, who performs risk management of the evaluator, such as a site manager, is additionally reflected. In addition, for each risk scenario, the evaluator, such as a site manager or the like, uses a PIS quantification technique based on the evaluated probability of risk occurrence (P), impact (I, based on loss amount), and significance information (S) to evaluate a corresponding risk into A, B, C, D and E, evaluate, confirm and manage the activity risk in a range of a scale of 1 to 10 as described above, or further visually confirm the evaluation using a three-dimensional matrix as shown in FIG. 2C.

In addition, the activity risk matrix for the construction type of each construction site or the individual activity of a specific construction site may be grouped by the unit of construction type or construction site, and shown as a three-dimensional risk matrix, and an example of the three-dimensional risk matrix may be as shown in FIG. 2C (a three-dimensional activity risk matrix according to an embodiment of the present invention).

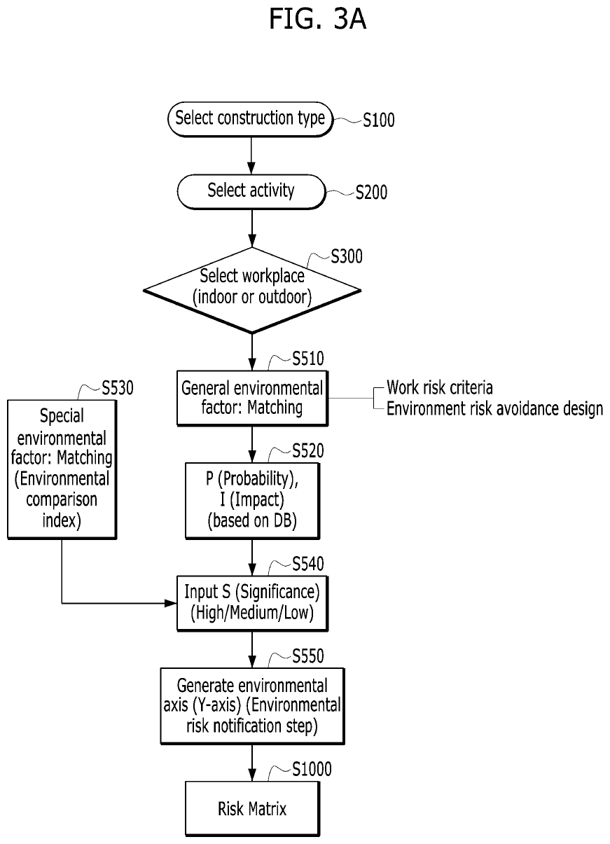

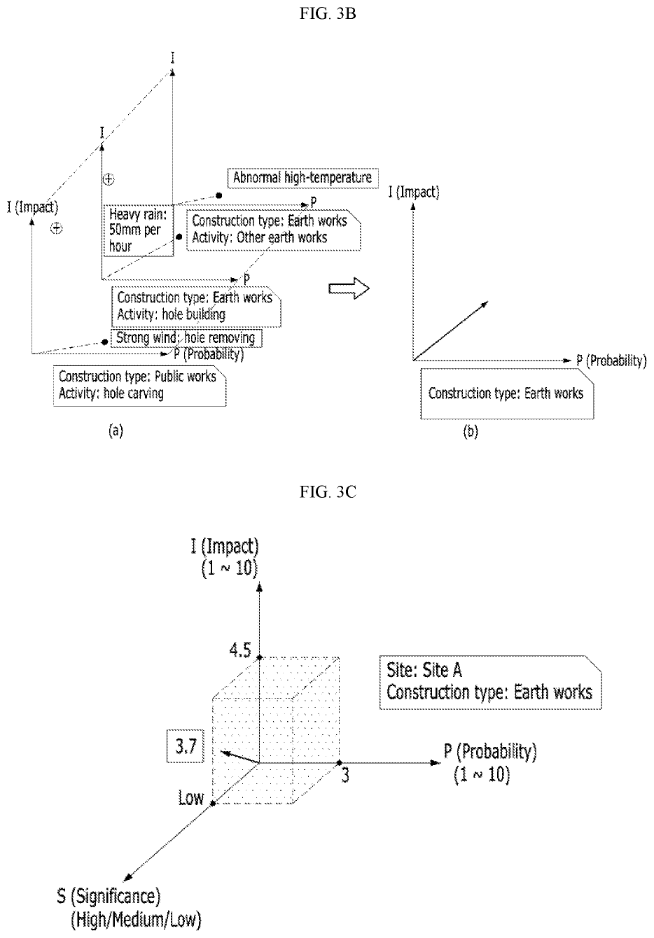

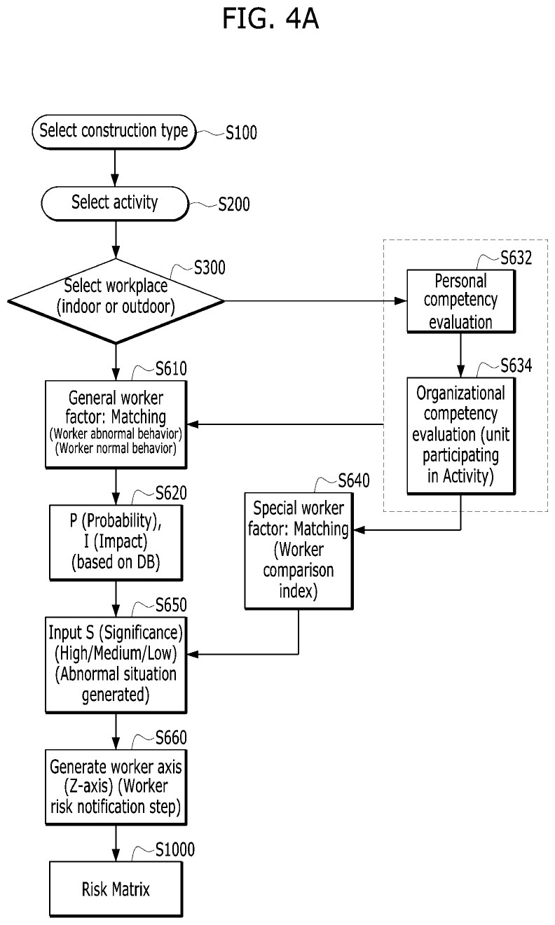

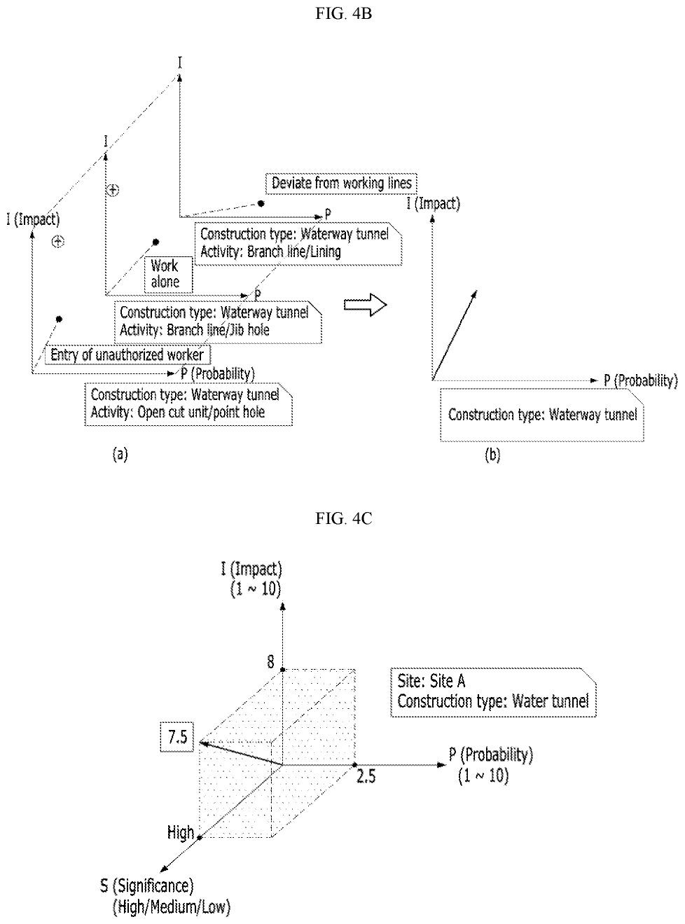

That is, the risk matrix according to an embodiment of the present invention may be provided in the form of a three-dimensional risk matrix, as shown in FIG. 2C, using the probability (P), impact (I), and significance (S) as axes for each individual construction type and/or individual activity. In addition, a value corresponding to an axis related to the probability (P) and the impact (I) that can be generated on the basis of past or present real-time observation data, for which a numerical value may be formed objectively, is provided on a scale having a range of 1 to 10, whereas a value corresponding to an axis related to the significance (S), to which a subjective numerical value of a manager or the like is reflected, may be inputted by reducing the width or scale that can be comparatively selected in comparison with other axes, such as high/medium/low of a relatively small width of change, to solve the problem of a result value varying according to the psychological state of a manager or determination of each manager (i.e., the significance (S) that can be felt or conceived by each manager may vary, and therefore, the index of the entire risk matrix or a portion where the numerical value may vary significantly is corrected). Therefore, it is possible to overcome to the limitation of significantly changing a risk matrix result value or an intermediate calculation value (a numeric value related to the risk) according to the propensity of a user, a manager or the like who progresses the evaluation on the basis of the risk matrix. This can be equally applied to the descriptions corresponding to FIG. 3C or FIG. 4C that will be described below.

The multi-dimensional risk matrix according to an embodiment of the present invention shown in FIG. 2C as an example shows a view of calculating a risk value of activity factors for a construction type “bridge”, and as shown in FIG. 2C, the probability (P) is 4.5 points on the basis of 10 points, the impact (I) is 5 points on the basis of 10 points, and the significance (S) is rated as “medium” among high/medium/low, and based on these individual values, it is possible to generate a three-dimensional vector value (a risk value calculated according to a preset method, such as an average, a weighted average, or a sum by addition and subtraction) (6.5 in FIG. 2C). However, the three-dimensional vector value may be calculated and drawn in various ways, such as being automatically calculated by a separately set algorithm or calculation formula, or being reflected and calculated considering an increase or decrease situation for one or more values of the probability (P), the impact (I), and the sensory level (I). This can be equally applied to the descriptions corresponding to FIG. 3C or FIG. 4C that will be described below.

For reference, although all the “sites” shown in FIGS. 2C, 3C, and 4C are marked as “site A”, alternatively, the point that a risk matrix can be generated in correspondence to each individual site corresponding to a plurality of diverse sites should also be considered.

After step S400, additional mitigating activities and resources for executing the mitigating activities are recommended and/or relocated for individual activities (or the construction site or the like) having a high risk level (or a vector value, see FIG. 2C), and the progress statue of executing the mitigating activities may be monitored, or its performance may be evaluated.

In addition, the activity axis generation step (S460) according to the present invention may further include an “activity risk notification step” of generating a pop-up window or a separate additional icon for notification of a specific risk situation, when it is evaluated that there is a risk accompanied with a specific construction type and/or a detailed activity, to support the site manager or the like to confirm the risk more easily. At this point, at the “activity risk notification step” described above, the pop-up window or the icon may be displayed at a predetermined position in a three-dimensional internal space of a matrix formed in three dimensions or placed along a three-dimensional matrix axis, and provided to draw attention of a manager or the like with blinks, a noticeable color or the like. In addition, when there is a plurality of risks, the pop-up window/icon size, the number and intensity of flashes, and the display position may vary according to preset risk rankings, such as in order of high probability (P) or high impact (I), and it may be supported to enlarge the pop-up window/icon or view the detailed risk contents in response to the click of the manager or the like.

In addition, the step (S400) of calculating the activity risk evaluation information according to the present invention may partition a plurality of regions that may be included in a construction type and/or an activity progressed in one or a plurality of regions in a predetermined pattern (e.g., may partition a region into construction sections, construction areas/zones or the like), calculate an activity risk for each of the partitioned regions through the process described above, and generate an activity risk matrix for each of the partitioned regions.

In addition, the step (S400) of calculating the activity risk evaluation information according to the present invention may further include, before step S100, a step of separately calculating a “regional risk index” partitioned considering “risk factors”, such as a soil or ground condition, presence of existing structures, presence of underground deposits, presence of neighboring slopes, surrounding construction environments and the like of each partitioned region, which may generate a disaster such as ground subsidence or the like due to an external environment such as abnormal weather and climate. In this case, the step of calculating the “regional risk index” may include the steps of setting an accident scenario for a partitioned region, extracting “risk factors” for a plurality of regions on the basis of evaluation of a risk occurred by a natural disaster such as strong wind, heavy rain or the like, evaluating a damage risk for the plurality of regions on the basis of the extracted “risk factors” and the set accident scenario, and calculating a “regional risk index” for the plurality of partitioned regions on the basis of the evaluated damage risk.

In addition, a method of calculating PI (probability and impact) and/or S (significance) mentioned at the step (S400) of calculating activity risk evaluation information according to the present invention, or a basic frame related to a matrix or an axis (X-axis) generated on the basis of PI and/or S may be equally applied to generation of an environment axis and/or generation of a worker axis, which will be described below.

Next, step S500 is a step of calculating environmental risk evaluation information by generating an environmental risk matrix for performing risk management and evaluation on the external environment, and may include a general environmental factor matching step (S510), an environmental PI calculation step (S520), a special environmental factor matching step (S530), an environmental significance (S) reflecting step (S540), and an environment axis generation step (S550).

Here, step S500 will be described in detail with further reference to FIG. 3A.

Specifically, at step S510, general environmental factors may be matched according to the selected construction type, activity, and workplace. Here, the general environmental factors may include comprehensive environmental information, such as geographic information and works of each construction type and activity of a construction site collected according to the construction type, activity, and workplace, and/or a season that may affect the duration or the like, and/or temperature, precipitation and wind speed according to the season. These general environmental factors may be weather and climate information during a set past period received from the DB, which is constructed based on the past weather and climate information data of a region (zone) corresponding to the target construction site, and/or from the Korea Meteorological Administration, an external service provider, or the like.

In addition, data on the external environmental conditions, such as weather and climate collected at step S510, may specify detailed location information on the basis of the address, the latitude and longitude coordinates, GIS or the like of the construction site (even in the case of a plurality of partitioned sites, each corresponds in plurality), and it may be various weather and climate data, such as temperature, wind speed, wind direction, rainfall, fine dust, precipitation type, sky condition, humidity, lightning condition, earthquake intensity, and the like corresponding to a site, inputted/received and stored on the basis of the location information specified like this.

In addition, at step S510 according to the present invention, after various weather and climate information is arranged by the type (temperature, wind speed, etc.) and the scores of the probability of meteorological disasters (fall of a structure due to strong wind, flood of underground structures due to heavy rain, etc.) within a set period (1 month, 6 months, 1 year, etc.) are statistically calculated, the number of days or times of generating statistically abnormal situations may be calculated on the basis of the past weather and climate data of a corresponding region (construction site). In addition, past incident and accident information about delay of construction or loss of life and/or property generated due to the weather and climate during a set period (construction period) at a construction site may be statistically analyzed and calculated by scoring and indexing the calculated number of statistically abnormal situations. In addition, step S510 may further include a step of calculating a final score of the probability by arithmetic average of the probability score calculated for each weather and climate type.

In addition, when structures of each altitude, i.e., high-rise structures or the like, are constructed, the climate and weather information may be stored or received by classifying weather and climate information, such as wind speed, wind direction, temperature, humidity and the like, which are different at each altitude, and weather and climate information of each altitude may be converted into a vertical distribution form and constructed as a DB on the basis of the past weather and climate information data. For example, for the weather and climate information considering vertical distribution by altitude, in the case of air temperature, change of air temperature at each altitude is calculated according to the standard atmospheric adiabatic lapse rate formula (−6.5° C./1000 m), or it may be considered that the dry adiabatic lapse rate is −0.8/km, and the wet adiabatic lapse rate is −4.5/km, and the actual air temperature may be applied by setting the temperature lapse rate to 6.5 on average. In addition, in the case of rainfall, the vertical distribution may be calculated as being the same, and in the case of wind speed, it may be set to increase as the height from the ground surface increases, considering the condition of the ground surface (green zone, bare ground, etc.) of the construction site or the height and closeness of structures such as surrounding buildings. In addition, in order to complementally secure the reliability of the past data, additional information on the external environmental conditions, such as various weather and climate and the like, is complementally collected by wind sensors, temperature sensors, humidity sensors, and the like formed at set locations such as inside and outside of a construction site, and may be used together for the evaluation described above and/or analysis, calculation and the like (reference data related to vertical distribution of weather and climate according to altitude. Korean Patent Registration No. 10-1,379,407).

In addition, as the general environmental factors, a correlation with an environmental variable of each selected construction type/activity and an environmental variable having a high environmental risk may be set to a work/duration on the basis of past statistical data.

In addition, as described above, step S510 may further include a step and process (“environmental risk avoidance design step”) of additionally presenting information on mitigating activities for risk avoidance and/or mitigation corresponding to weather and climate conditions according to the selected construction type, activity and workplace, in correspondence to risk information according to external environmental conditions such as weather and climate information or the like that may directly or indirectly affect an individual construction type and activity, and therefore, the site manager may be supported to recognize in advance a risk of a construction site work to be progressed at present or in the near future and establish countermeasures in advance.

In addition, at step S500 according to the present invention, i.e., the step of calculating environmental risk evaluation information, the general environmental factors described above may be reflected differently in correspondence to a place progressing a construction, such as indoor or outdoor, determined at the previous step S300. That is, in the case of an indoor work, a situation of no risk or decreased risk due to the influence of rain or the like may be considered, and in the case of an outdoor work, the general environmental factors according to the external environmental information for outdoor or indoor works may be added or subtracted in a way of further assigning a risk weighting value for the influence of abnormally high temperature or strong wind. In addition, in the case of an outdoor work, “work risk criteria” for each weather and climate type may be set in advance (e.g., in the case of a rebar reinforcement work for outdoor foundation, a criterion for stopping the work when the temperature is over 38→, etc.), and it is possible to calculate the number of days or times exceeding the “work risk criteria” for each type on the basis of the statistical values of past weather and climate data of a region corresponding to the construction site.

In addition, the general environmental factors (S520) according to the present invention may be collected by additionally reflecting the data on occurrence of construction accidents, which are caused by external environments such as weather and climate and occurring at various domestic and foreign construction sites in real time, in addition to the past statistical data, and causes and damages of the accidents through a wired/wireless communication network.

Next, step S520 is an environmental PI calculation step, and may calculate the probability (P) of occurrence of a safety accident and the impact (I) according to occurrence of the accident by reflecting general environmental factors. Here, data of a PI result value may be generated as a graph or an image of a two-dimensional axis or the like by calculating an average value of the environmental information of each section (which can be diversely calculated according to a setting such as for each unit construction type/activity, season, etc.) calculated through past statistical information, and reflecting statistical information related to accidents associated with each type of past weather and climate and/or work risk criteria in the risk according to the average value of corresponding environment information (temperature, wind speed, precipitation, etc.).

Here, the probability (P) and the impact (I) mean the probability (P) of occurrence of a construction accident in a construction site, which may be caused by external environmental conditions such as weather and climate for evaluating a risk, and the intensity of damage (I) according to occurrence of the accident, and for example, the probability of accidents such as major disasters of each construction type and activity (human accident, etc.), which are caused by fall of some structures under construction due to strong wind or collapse of the upper part of a tower crane, and the amount of loss according to occurrence of the accidents for each construction type, activity, and workplace may be expressed numerically and financially.

As shown in FIG. 3B, the environmental PI calculation step (S520) according to an embodiment of the present invention may derive the probability (P) of a past accident, which is caused by external environmental factors such as weather and climate or the like, for the detailed individual activities of each construction type and the impact (I, may be expressed in monetary figures) according to occurrence of the accident ((a) of FIG. 3B), and comprehensively calculate a detailed environmental PI value that affects each construction type and/or activity ((b) of FIG. 3B). In addition, the environmental PI may also be calculated by integrating all construction types of each construction site (for example, the graph as shown (b) of FIG. 3B for each construction type is generated for each construction type, and an environmental PI according to all construction types of a corresponding construction site is calculated by overlapping or combining a plurality of graphs generated for each construction type).

In addition, unlike (also together with) this, the data of the environmental PI result value described above may also be generated as a value digitized on a scale of 1 to 10 points.

Next, at step S530, special environmental factors may be matched to the selected activity. Here, step S530 of the special environmental factors may include the process of predicting external environmental conditions, such as predicting real-time (As-Is) environmental information (it may be weather and climate information such as temperature, precipitation, and/or wind speed measured in real-time on the basis of a sensors network built on the site) within the selected region/zone/area/range where the activity is in progress (it may be one or more construction sites for which a risk is evaluated) and/or future (to-Be) weather and climate information targeting the set region/zone/area/range during the entire construction period or a set period, and analyzing an effect on a detailed construction work according to the construction type and activity of a corresponding construction site. That is, unlike the general environmental factors based on past statistical data such as past weather and climate information, the special environmental factors (reflecting As-Is and/or To-Be information) at step S530 is different in that external environmental conditions such as weather and climate information or the like may be expected for a future period (within a set period range, for example, the entire period of a construction work) of a set zone such as a corresponding construction site on the basis of current weather and climate information (external environmental conditions) and past and current weather and climate information that can be measured and/or received through a sensor and/or a network, and the external environmental conditions may be reflected in detailed construction types and activities.

At this point, environmental variables applied to the special environmental factors described above may be reflected by specifically differentiating the altitude, location, and width of a section, zone, or region, in which detailed construction works are progressed (wind speed, wind direction, temperature, and humidity of each altitude, refer to the above description), and the life weather index, the health weather index and/or the industrial weather index provided by the National Weather Service may be interconnected, or all or some of them may be reflected.

In addition, prediction within a set period of external environmental conditions, such as forecasting future weather and climate, may be made by using or associating the Monte Carlo algorithm, a random forest method, or the CALMAT diagnosis model, UM LSAPS, CWW3, GDAPS, and the like, which are the weather and climate information forecast and diagnosis models of the Korea Meteorological Agency.

Next, step S540 corresponds to a step, in which a site manager or the like comprehensively determines external environmental conditions such as past weather and climate information (general environmental factors) and current (and/or future) weather and climate information (special environmental factors) for a corresponding construction site, and evaluating and inputting a subjective environmental significance (S) for each construction type and activity. That is, at step S540, the environmental significance (S) for the environmental risk of the construction site itself may be evaluated by the manager within a preset grade.

That is, step S540 according to the present invention may be defined as a step capable of deriving and evaluating potential risks by mutually and relatively comparing the past (based on statistical data), current (based on sensor measurement data) and/or future (Monte Carlo simulation based on algorithm prediction data) weather and climate information of a corresponding construction site (one or more sites may be targeted), such as weather climate information or the like. In addition to this, environmental risks according to external environmental information such as weather and climate of a corresponding construction type and activity and detailed works according thereto (and work location information may be included) may be calculated on the basis of statistical data of external environmental information such as past weather and climate, current real-time sensing data (based on the wind speed, wind direction, temperature sensors installed inside and outside the construction site), and future forecast climate and weather information in accordance with a period (the period may be set to month, day, time zone, etc.) corresponding to the construction type and each detailed work schedule according to the construction type.

In addition, the environmental significance (S) according to the present invention may be graded only on a 3-score scale of high/medium/low. However, unlike the past statistical data (PI value, derived through step S520), which can be objectively digitized and derived, it is preferable to simplify the evaluation index at the significance (S) input step, considering the limitation of being subjectively evaluated by the site manager or the like, to reduce the error according to the subjective determination of the evaluator more than the evaluation index at step S520. For example, the evaluation index at step S520 has a wide evaluation range on a scale of 1 to 10, whereas at step S540, as the selection range that can be assigned for each evaluator is reduced by narrowing the evaluation range (interval) such as high/medium/low, possibility of generating an error according to the perspective of each evaluator can be minimized.

For example, the environmental significance (S) may be graded only on a 3-score scale of high/medium/low, and a site manager or the like may evaluate the environmental significance (S) on the 3-score scale of high/medium/low, and the environmental significance (S) may be additionally reflected by being added to or subtracted from the PI result value derived at the environmental PI calculation step S520.

In addition, the environmental significance (S) may be added to or subtracted from the PI result value considering ease of executing the mitigating activities, whether or not possessing execution assets and the like, and a three-dimensional matrix based on the PI and S values may also be generated together (or separately).

In addition, in evaluating the environmental significance (S), whether the mitigating activities derived and presented together at the general environmental factor matching step (S510) are reflected in the construction site, which is an actual evaluation target, in the process of risk evaluation is also reflected at step S540, so that evaluation of the environmental significance (S) of the site evaluator or the like may be supported. That is, for example, when the atmosphere is stagnant in a situation where an indoor work is to be progressed and indoor carbon dioxide or harmful gas is not discharged smoothly to the outside, the environmental significance (S) may be evaluated by reflecting whether the mitigating design and the mitigating activities for the environmental risks, such as providing a separate safety mask or additionally installing a ventilator or the like, are reflected in the corresponding activity and work.

In addition, the environmental significance (S) according to the present invention may be additionally reflected by being added to or subtracted from the PI result value derived at the environmental PI calculation step (S520). For example, the environmental significance (S) may be added to or decreased from the PI result value considering ease of executing the mitigating activities, whether or not possessing execution assets, and the like.

Next, step S550 is an environment axis generation step, and may generate an environmental risk matrix. Here, the environmental risk matrix may be generated by drawing the probability (P), the impact (I), and the environmental significance (S) in three dimensions. In this environmental risk matrix, vector values may be calculated as environmental risk evaluation information (see FIG. 3C).

In summary, at step S500, on the basis of past climate history data based on the location information of a construction site, the current climate data of the construction site is sensed to reflect real-time environmental information, and it is possible to analyze the probability of risk occurrence for each activity (including work delay date) and derive the environment axis (Y-axis) that quantifies the probability by predicting (based on simulation) climate during the construction period (in the future).

After step S500, a climate representative value of each season (section) is set in the general environmental factors, and when it deviates from the representative value at an actual activity/performance task step, the environmental significance (S) and/or the environmental risk may be additionally added or reduced.

In addition, the environmental risk matrix for the construction type of each construction site or the individual activity of a specific construction site may be grouped by the unit of construction type or construction site, and shown as a three-dimensional risk matrix, and an example of the three-dimensional risk matrix may be as shown in FIG. 3C.

In addition, after step S500, additional mitigating activities and resources for executing the mitigating activities are recommended and/or relocated considering the environmental risk for individual activities (or the construction site or the like) having a high risk level (or a vector value, see FIG. 3C), and the progress statue of executing the mitigating activities may be monitored, or its performance may be evaluated.

That is, the multi-dimensional risk matrix according to an embodiment of the present invention shown in FIG. 3C as an example shows a view of calculating a risk value of the environmental factors for an “earthwork”, which is one of individual construction types, and as shown in 3b, the probability (P) is 3 points on the basis of 10 points, the impact (I) is 4.5 points on the basis of 10 points, and the significance (S) is rated as “low” among high/medium/low, and based on these individual values, it is possible to generate a three-dimensional vector value (a risk value calculated according to a preset method, such as average, weighted average, or a sum by addition and subtraction) (3.7 in FIG. 3C).

In addition, the environment axis generation step (S550) according to the present invention may further include an “environmental risk notification step” of generating a pop-up window or a separate additional icon for notification of a specific risk situation, when it is evaluated that there is a risk related to external environments directly or indirectly affecting a specific construction type and/or a detailed activity, to support the site manager or the like to confirm the risk more easily. At this point, at the “environmental risk notification step” described above, the pop-up window or the icon may be displayed at a predetermined position in a three-dimensional internal space of a matrix formed in three dimensions or placed along a three-dimensional matrix axis, and provided to draw attention of a manager or the like with blinks, a noticeable color or the like. In addition, when there is a plurality of risks, the pop-up window/icon size, the number and intensity of flashes, and the display position may vary according to preset risk rankings, such as in order of high probability (P) or high impact (I), and it may be supported to enlarge the pop-up window/icon or view the detailed risk contents in response to the click of the manager or the like.

In addition, the step (S500) of calculating the environmental risk evaluation information according to the present invention may partition a plurality of regions that may be included in a construction type and/or an activity progressed in one or a plurality of regions in a predetermined pattern (e.g., may partition a region into construction sections, construction areas/zones or the like), calculate an environmental risk for each of the partitioned regions through the process described above, and generate an environmental risk matrix for each of the partitioned regions.

In addition, the step (S500) of calculating the environmental risk evaluation information according to the present invention may further include, before step S100, a step of separately calculating a “regional risk index” partitioned considering “risk factors”, such as a soil or ground condition, presence of existing structures, presence of underground deposits, presence of neighboring slopes, surrounding construction environments and the like of each partitioned region, which may generate a disaster such as ground subsidence or the like due to an external environment such as abnormal weather and climate. In this case, the step of calculating the “regional risk index” may include the steps of setting an accident scenario for a partitioned region, extracting “risk factors” for a plurality of regions on the basis of evaluation of a risk occurred by a natural disaster such as strong wind, heavy rain or the like, evaluating a damage risk for the plurality of regions on the basis of the extracted “risk factors” and the set accident scenario, and calculating a “regional risk index” for the plurality of partitioned regions on the basis of the evaluated damage risk.

In addition, a method of calculating PI (probability and impact) and/or S (significance) mentioned at the step (S500) of calculating environmental risk evaluation information according to the present invention, or a basic frame related to a matrix or an axis (Y-axis) generated on the basis of PI and/or S and the matters described above may be equally applied to generation of a worker axis (or matrix) and/or generation of an activity axis (or matrix), which will be described below.

Step S600 is a step of calculating worker risk evaluation information by generating a worker risk matrix for performing risk management and evaluation on a worker participating in an activity, and may include a general worker factor matching step (S610), a worker PI calculation step (S620), a worker competency evaluation step (S630), a special worker factor matching step (S640), a worker significance (S) reflecting step (S650), and a worker axis generation step (S660).

Here, step S600 will be described in detail with further reference to FIG. 4A.

Specifically, at step S610, general worker factors may be matched according to the selected construction type, activity, and workplace. Here, the general worker factors may include categorized as indoor or outdoor the properties of workers deployed in a predetermined performance task (field work) of each individual activity, the number of workers required for each performance task, a required work space, equipment-related works and like by the types of the construction and activity (and/or a selected workplace) selected according to a workplace classified as indoor or outdoor.

In addition, as the general worker factors, information on standard performance indexes according to the job skill of each job position and competency level may be set according to the selected activity.

In addition, as the general worker factors according to the present invention, “worker abnormal behavior” and/or “worker normal behavior”, which are generated by further subdividing the causes of disaster accidents or the like generated by carelessness, negligence or intention of a worker previously generated at the construction work site, may be inputted by grouping and subdividing in advance.

In addition, the general worker factors according to the present invention may reflect the data generated at a personal competency evaluation step (S632) and/or an organizational competency evaluation step (S634), which will be described below. That is, the general worker factors may reflect statistical data of individual workers (personal competency) such as general physical features including the qualification, career, completion of training, language communication ability, age, gender and the like of a worker participating in a detailed task (work) in a construction site of each construction type and activity the same as or similar to those of the past corresponding to each construction type and activity, and/or average statistical data on organizational competency including average work capability, organizational experience and the like of an organization unit participating in a detailed task (work) of each construction type and activity the same as or similar to those of the past corresponding to each construction type and activity.

In addition, the general worker factors (S610) according to the present invention may be collected by additionally reflecting the data on occurrence of construction accidents, which are caused by the workers participated in the construction work and have occurred at various domestic and foreign construction sites in real time, in addition to the past statistical data, and causes and damages of the accidents through a wired/wireless communication network.

In addition, as described above, the general worker factor matching step (S610) according to the present invention may further include a step and process (“worker risk avoidance design step”) of presenting risk information contained for each individual field worker and/or work organization unit and information on mitigating activities for risk avoidance and/or mitigation according to the selected construction type, activity, and workplace, and therefore, the site manager may be supported to recognize in advance, from the viewpoint of a worker, a risk of a construction site work to be progressed at present or in the near future and establish countermeasures in advance.

Next, step S620 is a worker PI calculation step, and may calculate the probability (P) of occurrence of a safety accident and the impact (I) according to occurrence of the accident by reflecting general worker factors.

At the worker PI calculation step like this, data of a worker PI result value may be generated on a multi-dimensional, such as two-dimensional axis, by reflecting past accident statistical information of each activity selected on the basis of past statistical information and information on workers deployed in the performance task. For example, the data of worker PI result value may be generated on a scale of about 1 to 10 points.

Step S620 according to the present invention may calculate the probability (P) of occurrence of a safety accident by a worker and the impact (I) according to occurrence of the accident by reflecting general worker factors. Here, data of a PI result value may be generated as a graph or an image of a two-dimensional axis or the like by calculating an average value of information digitized for each section calculated through past statistical information (which can be diversely calculated according to a setting such as for each unit construction type/activity, season, etc.), and for each worker and organization unit participating in a unit activity (or for each work) described below, and reflecting statistical information related to accidents associated with each type of worker information data and/or work risk criteria in the risk according to the average value (education level, career, experience, body condition, etc.) of corresponding (individual and/or organizational) worker information.

Here, to evaluate a risk, the probability (P) and the impact (I) may be digitized on the basis of disaster accident occurrence statistical data generated by individual or organizational workers of each construction type and activity the same or similar to the construction type and activity of a construction site currently being targeted. That is, the probability (P) and the impact (I) may be expressed as a matrix, a chart, or a numerical value within a set range (the probability of an accident occurring due to abnormal worker behaviors, and the impact such as the amount of loss according thereto) by reflecting them in the current construction type and activity, on the basis of statistical data on the generation of a gap according to negligence, intention or the like of individual/organizational workers and generation of disaster according thereto based on the criteria set for “worker abnormal behavior” and/or “worker normal behavior”.

As shown in FIG. 4B, the PI calculation step (S620) according to an embodiment of the present invention may derive the probability (P) of a past disaster accident caused by human disaster and the impact (I, may be expressed in monetary figures) due to the occurrence of the disaster accident on the basis of statistical data related to individual and/or organizational workers for each detailed activity of each construction type, i.e., in a detailed activity in which an individual worker participating in the detailed task (work) and/or individual workers configured as a unit organization and participating in ((a) of FIG. 4B), and then comprehensively calculate a detailed worker PI value that affects each construction type and/or activity ((b) of FIG. 4B). In addition, the worker PI may also be calculated by integrating all construction types of each construction site (for example, the graph as shown (b) of FIG. 4B for each construction type is generated for each construction type, and a worker PI according to all construction types of a corresponding construction site is calculated by overlapping or combining a plurality of graphs generated for each construction type).

In addition, unlike (also together with) this, the data of the worker PI result value described above may also be generated as a value digitized on a scale of 1 to 10 points.

Next, step S630 is a worker competency evaluation step of calculating a competency index by evaluating competency of a worker, and may include a personal competency evaluation step (S632) of calculating a personal competency index by evaluating personal competency, and an organizational competency evaluation step (S634) of calculating an organizational competency index by evaluating organizational competency.

In addition, step S630 of the present invention classifies and generates past statistical data on individual and organizational workers participated in a detailed task (work) of a construction type and activity the same as or similar to those of the past according to the types such as the contents of “Table 1” shown below.

In addition, step S630 of the present invention may further include a step of comprehensively evaluating competency of construction workers (individuals) on the site actually deployed (As-Is) or will be deployed (To-Be) for each construction type and activity of individual construction sites to be evaluated and a set of organization units of collecting and deploying workers.

At step S632, the personal competency index may be calculated using the physical competency index (A-axis) and the work competency index (B-axis). At this point, at step S632, as shown in “Table 1” below, competency evaluation for each individual worker may be performed by calculating a personal competency index reflecting special personal information that may affect the work, as well as general personal information of the individual worker, such as medical biological age, stress sensitivity and the like.

TABLE 1

| A-axis check items | B-axis check items |
|---|---|
| Gender | Education |
| Health examination physical | Experience |
| age (medical biological age | Communication ability |
| age) | Possession of related licenses |
| Stress sensitivity | Communication and verbal |
| Extroverted/introverted | ability (Foreigner, etc.) |
| tendency identification | Positions (reflect weighting |
| Height/Weight/Vision etc. | value) |
| Blood pressure/blood | Latest years of working |
| sugar/color blindness, etc. | — |
| Smoking | |
| Specific disease | |

Step S634 is a process of calculating an organization unit competency index for each activity, and a more practical index may be calculated by reflecting an index of individual workers participating in the activity, such as whether the number of workers deployed in the activity is appropriate, whether a work should be performed by team, or whether a special qualification requirement related to the activity is needed from the perspective of correlation analysis.

As shown in FIG. 5, step S634 like this may include the step of inputting and/or calculating deployed workers (S634-1), obtaining an arithmetic average of a competency index for the deployed workers (S634-3), reflecting activity environmental factors to reflect issues related to workers of an activity itself (S634-5), and calculating an organizational competency index (S634-7).

For example, an average value of a personal competency index is obtained at step S634-3, and at step S634-5, issues related to workers of an activity itself, such as whether the number of deployed workers is appropriate (e.g., too small/too large, etc.), whether a work is performed by team (e.g., in pairs of two persons), a special qualification requirement related to the activity, may be reflected.

Next, at step S640, special worker factors may be matched to the selected activity. Here, the special worker factors may include, on the basis of a result of competency evaluation for individual workers and organizations, items that require individual consideration on individual workers participating in a unit activity, such as a work environment, a workload, a labor time, body conditions, possibility of occurrence of a state risk according to the environment, and the like in a construction activity in which individual and/or organizational workers are deployed, i.e., information that needs to be additionally reviewed or considered for individual factors that can be ignored in a statistical organizational competency evaluation.

These special worker factors may be additionally set to calculate a risk of moving lines of construction equipment such as dump trucks or the like, regions overlapping with a work zone (e.g., movement of equipment, work moving lines, and real-time work of field workers), and the like. To this end, the construction equipment deployed in the construction site to perform or will perform works or movements may include a sensor network capable of monitoring in real-time whether or not independent operation, moving directions, moving lines in the workplace and the like.

In addition, the special worker factors at the special worker factor matching step (S640) according to the present invention refer to information on field workers (individuals) actually deployed (or will be deployed) according to a selected construction type and activity, and conditions of workers of each organization (unit) to work together for each activity (work), and may be classified and grouped as described above on the basis of the classification system as shown in “Table 1”. That is, the special worker factor matching step (S640) according to the present invention may progress competence evaluation for individual workers in the site and/or unit organization actually deployed (As-Is) (or to be deployed according to a predetermined activity sequence or the like (To-Be)) in a construction site.

In addition, the special worker factor matching step (S640) may include a step of receiving an input of individual history of various construction equipment actually deployed in a construction site, and actual data on preliminary factors related to installation or the like that should be prepared in advance to progress a set work from a site manager or the like, or receiving, inputting, managing, and storing the history and data through various sensors or the like installed in the individual equipment.

That is, unlike the general activity factors generating a risk by a worker on the basis of disaster occurrence information generated according to intention, negligence, carelessness or the like of a (individual/organizational) worker deployed according to the construction type and activity on the basis of past statistical data, the special worker factors (reflecting As-IS information) according to the present invention has a difference capable of collecting, reflecting and digitizing actual information, such as body conditions and experience of construction workers or the like actually deployed in a corresponding construction site (refer to “Table 1” for detailed classification criteria).

In addition, the special worker factor matching step (S640) according to the present invention may generate and evaluate a separate “worker comparison index” by relatively comparing information on average experience and career, accident history, body conditions such as age, and the like of an individual worker generally deployed according to the construction type, activity, and workplace confirmed through the individual worker factor matching step (S632) with average experience and career, accident history, body conditions such as age, and the like of an individual worker actually deployed in the site. The “worker comparison index” is presented as a numerical value or the like at the significance (S) input step (S650) described below so that a site manager or the like may utilize in increasing or decreasing the possibility of an accident risk of the workers actually deployed or the risk of entire construction types, activities, and the like. For example, when the body and education level (refer to “Table 1” for detailed indexes) of field workers actually deployed (to be deployed in the future) in a corresponding construction site is compared with that of generally deployed field workers and the physical competency (age or muscular strength condition), experience, qualification level or the like of the workers deployed in a corresponding construction site is more excellent, a relatively higher score is given to the “worker comparison index” generated at the special worker factor matching step (S640), and the score given in this way is presented at the significance (S) input step (S650) to support the site manager or the like to evaluate by further mitigating the possibility of occurrence of risks at the significance input step. The “worker comparison index” like this may be expressed in a scale unit of 1 to 10. Accordingly, when construction workers having excellent competency in physical, educational, and psychological aspects compared with field workers generally deployed in the same or similar construction type and activity, they may be used as one of executions of mitigating activities that can be derived at step S610.

In addition, the special worker factor matching step (S640) calculates the risk of each region/zone/area/range in an activity that reflects the correlation between the risk of a worker in a set region/zone/area/range (body conditions or the like of field workers deployed in a corresponding activity) and external environmental conditions, and may be used to calculate a real-time and/or predicted risk of each worker by reflecting current and/or future external environmental condition information. To this end, the “worker comparison index” may be additionally generated by relatively comparing an average value of occurrence of accidents (based on past data) according to an evaluation result of individual/organizational competency (grade, number, etc.) generally deployed in each construction type and activity evaluated at the organizational competency evaluation step (S634), with the possibility of occurrence of accidents according to an evaluation result of field workers deployed in a construction site, which is a target of actual evaluation (based on the data transferred and received through a network of sensors attached to the protective gears such as a helmet or the like of the field workers currently progressing field works). The “worker comparison index” like this is associated with virtual sensors or the like installed in the construction site, and may progress determination or evaluation of possibility of risk of field workers for each individual/organization according to external weather environments (wind speed, wind direction, outside temperature, humidity, rainfall, etc.). In addition, prediction information on the possibility of occurrence of accidents, such as contact or the like between construction equipment and workers, is additionally generated as an index for comparison (past-present-future), considering external work constraints according to external environmental conditions such as arrangement and movement of field workers, abnormally high temperature, strong wind, and the like of each individual/organization or moving lines, moving range or the like of the construction equipment, so that the index like this may be considered at the significance (S) input step (S650).

At step S650, a manager or the like may subjectively evaluate a risk of worker itself at the current point. That is, at step S650, the worker significance (S) for the worker risk of the deployed workers may be evaluated by the manager within a preset grade. For example, the worker significance (S) may be graded on a 3-score scale of high/medium/low.

The worker significance (S) like this may be additionally reflected by being added to or subtracted from the PI result value derived at the worker PI calculation step (S620). For example, the worker significance (S) may be added to or decreased from the PI result value considering ease of executing the mitigating activities, whether or not possessing execution assets, and the like.

In addition, step S650 according to an embodiment of the present invention may also include a step of setting a unit zone, region, area, section or site in advance in which each activity is progressed, and monitoring movement of construction equipment and/or field workers deployed in the construction site in real-time through a network including a video surveillance (CCTV, etc.), a motion sensor, and the like. That is, step S650 may further include a step of monitoring abnormal situations in real-time and informing a set manager or the like of the situations (“abnormal situation notification”) such as generation of a behavior of working alone a work to be done by a group of two, a behavior of entering a dangerous zone without prior permission, or a behavior of disappearing from the view of co-workers in a detailed work or the like in which a plurality of workers participates, in the case where the “worker abnormal behavior” described above, i.e., behaviors that do not meet a preset criterion, for example, when a worker (object) deviates from predetermined coordinates (coordinates in the upper region of the facility) on an image or when a crane (object) enters into predetermined coordinates (coordinates of a virtual Pence area) on an image.

Next, step S660 is a worker axis generation step, and may generate a worker risk matrix. Here, the worker risk matrix may be generated by drawing the probability (P), the impact (I), and the worker significance (S) in three dimensions. In this worker risk matrix, vector values may be calculated as worker risk evaluation information (see FIG. 4C).

That is, the multi-dimensional risk matrix according to an embodiment of the present invention shown in FIG. 4C as an example shows a view of calculating a risk value of the worker factors for a construction type “waterway tunnel”, and as shown in FIG. 4C, the probability (P) is 2.5 points on the basis of 10 points, the impact (I) is 8 points on the basis of 10 points, and the significance (S) is rated as “high” among high/medium/low, and based on these individual values, it is possible to generate a three-dimensional vector value (a risk value calculated according to a preset method, such as an average, a weighted average, or a sum by addition and subtraction) (7.5 in FIG. 4C).

In summary, at step S600, on the basis of general statistical information (past statistical data) of a worker and an organization deployed in individual unit activities or performance task units, it is possible to derive a worker axis (Z-axis) that can evaluate adequacy of currently deployed workers, competency of organizational unit of individual workers, and adequacy of a work, and predict and diagnose occurrence of current and future risks through an evaluation result of currently deployed individual workers. In addition, the worker risk matrix for individual activities may be grouped by the unit of construction type or construction site and may be shown as a three-dimensional risk matrix.

In addition, the worker risk matrix for the construction type of each construction site or an individual activity of each specific construction site may be grouped by the unit of construction type or construction site and may be shown as a three-dimensional risk matrix, and an example of the three-dimensional risk matrix may be as shown in FIG. 4C.

In addition, after step S600, additional mitigating activities and resources for executing the mitigating activities are recommended and/or relocated considering the worker risk for individual activities (or the construction site or the like) having a high risk level (or a vector value, see FIG. 4C), and the progress statue of executing the mitigating activities may be monitored, or its performance may be evaluated.

In addition, the worker axis generation step (S660) according to the present invention may further include a “worker risk notification step” of generating a pop-up window or a separate additional icon for notification of a specific risk situation, when it is evaluated that there is a worker-related risk (refer to detailed indexes or the like of “Table 1”) directly or indirectly affecting a specific construction type and/or a detailed activity, to support the site manager or the like to confirm the risk more easily. At this point, at the “worker risk notification step” described above, the pop-up window or the icon may be displayed at a predetermined position in a three-dimensional internal space of a matrix formed in three dimensions or placed along a three-dimensional matrix axis, and provided to draw attention of a manager or the like with blinks, a noticeable color or the like. In addition, when there is a plurality of risks, the pop-up window/icon size, the number and intensity of flashes, and the display position may vary according to preset risk rankings, such as in order of high probability (P) or high impact (I), and it may be supported to enlarge the pop-up window/icon or view the detailed risk contents in response to the click of the manager or the like.

In addition, the step (S600) of calculating the worker risk evaluation information according to the present invention may partition a plurality of regions that may be included in a construction type and/or an activity progressed in one or a plurality of regions in a predetermined pattern (e.g., may partition a region into construction sections, construction areas/zones or the like), calculate a worker risk for each of the partitioned regions through the process described above, and generate a worker risk matrix for each of the partitioned regions.

In addition, a method of calculating PI (probability and impact) and/or S (sensory level) mentioned at the step (S600) of calculating worker risk evaluation information according to the present invention, or a basic frame related to a matrix or an axis (Y-axis) generated on the basis of PI and/or S and the matters described above may be equally applied to generation of an activity axis (or matrix) and/or generation of an environment axis (or matrix).

After step S600 like this, through the calculation of worker risk evaluation information, follow-up management such as relief or the like may be performed by monitoring individual workers participating in a performance task.

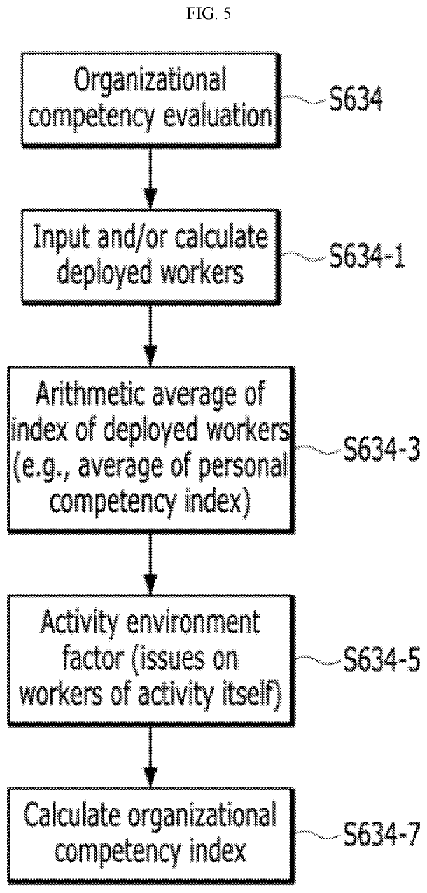

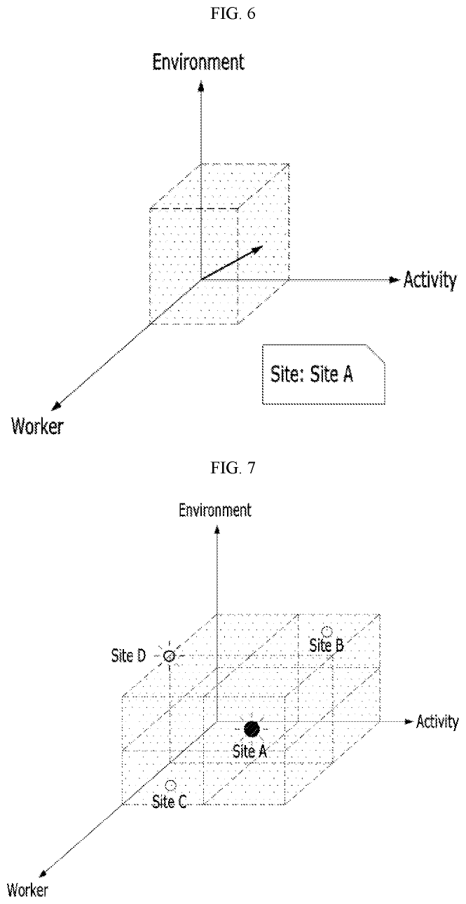

As shown in FIG. 6, at step S1000, a multi-dimensional risk matrix according to the present invention may be generated by combining all or some of the activity (X-axis), environment (Y-axis) and/or worker (Z-axis) described above (e.g., the matrix may be generated by adding X-axis and Y-axis values or calculating an average value). That is, after calculating all the activity, environment and/or worker risks described above (or numerical or vector values on the axes), these may be regenerated as a three-dimensional matrix.

In addition, step S1000, which is a step of generating a multi-dimensional risk matrix according to the present invention, may generate a three-dimensional matrix or a multi-dimensional graph by directly digitizing risk values for each of activity, environment and/or worker, after steps S450, S540 and/or S650 described above without separately having steps S460, S550 and/or S660, and the multi-dimensional risk matrix may be generated by digitizing a risk matrix or risk values associating “activity-worker”, “activity-environment”, and “worker-environment”.

That is, the multi-dimensional risk matrix according to the present invention, as shown in FIG. 6, is formed of axes divided into activity, worker and environment, and values corresponding to each axis are formed and provided as a multi-dimensional risk matrix that can be individually or comprehensively and visually confirmed according to selection of an individual construction type, an individual activity, an individual site, or a plurality of collective sites. At this point, a numerical value corresponding to each axis is derived by the step of generating a risk value for each activity, worker and/or environment described above, and may be generated by reflecting each derived risk value again (a method of calculating an average, a weighted average, a sum or the like of each preset risk value set in advance).

In addition, as shown in FIG. 7, for comprehensive and relative risk comparison and determination for a plurality of scattered construction sites (or sections), risk analysis results of two or more construction sites (Site A to Site D) may be displayed together in one matrix. (for example, it may be used for relative risk evaluation or the like for a plurality of construction sites where one construction company is currently carrying out construction works).

In addition, it is possible to support comprehensive risk evaluation by calculating an average of risk result values of a plurality of construction sites or assigning a weighting value that is set considering business cost or importance of the business (for example, the central government or local governments may evaluate and determine all or individual risks in real-time for a plurality of construction sites operated by a plurality of construction companies).

Meanwhile, in the method for generating a multi-dimensional risk matrix according to an embodiment of the present invention, steps S400, S500 and S600 may be selectively performed regardless of the description order, and a multi-dimensional risk matrix of one among activity, environment, and worker may be generated by performing any one step among steps S400, S500 and S600 after performing steps S100 to S300 described above.

In addition, in still another embodiment of the present invention, a multi-dimensional risk matrix generated through a multi-dimensional risk matrix generation method may be provided.

According to an embodiment of the present invention, it is possible to generate a multi-dimensional risk matrix that supports to associate comprehensive risk determination, evaluation, and follow-up supports from the aspect of activity, environment, and worker on the basis of past statistical data, calculate an actual risk of a corresponding activity by independently analyzing and calculating risks of activity, environment, and worker that may have a major influence on a construction work, increase practical utilization by reflecting actual evaluation of a manager, reflect special factors to additionally review individual factors that can be ignored in statistically analyzed general factors, determine and evaluate in advance a risk generated by an interference relation among various construction “types” or “activities”, diagnose and evaluate a potential risk of each “construction type” and/or “activity” quantitatively (e.g., in the form of a matrix), as well as various changes in the internal and/or external environments of a construction site (including weather information such as wind direction, wind speed, temperature, rainfall, snowfall and the like of each altitude), and change of the working period due to changes in the site conditions such as conditions (health, competency, experience, body condition, etc.) of deployed field workers, and manage and monitor a plurality of construction sites in real-time by a site manager or remotely by numerically converting information on a risk that may generate in a more complex construction site, such as an association of activity-environment, an association of activity-worker, an association of activity-environment-worker and the like, as well as numerical and quantitative evaluation of a risk that an activity itself has, and as it is supported to manage, monitor, and evaluate, on the site and/or remotely, potential risks such as a human accident or the like that may occur in a plurality of construction sites, on the basis of individual business period of each construction site, such as supporting to determine change of business plan, change of design, change of work schedule, deployment of additional facilities/workers and the like based on the potential risks, it may support to prevent human accidents or the like in advance, and perform safety management of a construction site more efficiently.

It should be understood that the effects of the present invention are not limited to the above-described effects, and include all effects that can be deduced from the configuration of the invention described in the detailed description or claims of the present invention.

The scope of the present invention should be construed to include the meaning and scope of the claims and any changed or modified forms derived from the equivalent concept thereof within the scope of the present invention.

What is claimed is:

1. A multi-dimensional risk matrix generation method for performing comprehensive risk management and evaluation on a construction activity, an external environment, and workers participating in the activity, the method comprising:
a step of calculating activity risk evaluation information through
a facility factor evaluation step of evaluating facility factors by reflecting information on facilities deployed in the activity according to selection of a construction type, an activity, and a workplace in which the activity is progressed,
an activity PI calculation step of calculating a probability (P) of occurrence of a safety accident for each activity step and an impact (I) according to occurrence of the accident by reflecting the facility factors and previously collected general activity factors, and
an activity significance (S) reflecting step of additionally reflecting an activity significance (S) reflecting previously collected special activity factors in a PI result value of the activity PI calculation step;
a step of calculating environmental risk evaluation information through
an environmental PI calculation step of calculating a probability (P) of occurrence of a safety accident and an impact (I) according to occurrence of the accident by reflecting previously collected general environmental factors according to selection of the construction type, the activity, and the workplace in which the activity is progressed, and
an environmental significance (S) reflecting step of additionally reflecting an environmental significance (S) reflecting previously collected special environmental factors in a PI result value of the environmental PI calculation step; and
a step of calculating worker risk evaluation information through
a worker PI calculation step of calculating a probability (P) of occurrence of a safety accident and an impact (I) according to occurrence of the accident by reflecting previously collected general worker factors according to selection of the construction type, the activity, and the workplace in which the activity is progressed,
a worker competency evaluation step of calculating a competency index by evaluating competency of a worker deployed in the activity, and
a worker significance (S) reflecting step of additionally reflecting a worker significance (S) reflecting the competency index and previously collected special worker factors in a PI result value of the environmental PI calculation step, wherein
the activity risk evaluation information, the environmental risk evaluation information, and the worker risk evaluation information are drawn in three dimensions.

2. The method according to claim 1, wherein
the facility factor evaluation step includes:
an individual facility factor evaluation step of evaluating individual facility factors by reflecting information on individual facilities deployed in the activity; and
a collective facility factor evaluation step of evaluating collective facility factors by comprehensively reflecting information on a collective facility configured of a plurality of facilities, wherein
the individual facility factor evaluation step receives incident and accident information, which is generated by individual construction equipment at a construction site and includes at least one among a type and a frequency of an accident occurred by the construction equipment, the number of accidents occurred by the equipment in each set period and an accumulated number of the accidents, standard years of use, and durability of each major component, and risk information according to the incident and accident information, on the basis of statistical data related to construction site accidents occurred in the past according to operation of various construction equipment, from its own database or outside, and reflects the incident, accident and risk information in evaluation of the individual facility factors, and the collective facility factor evaluation step categorizes accident occurrence issues generated by contact or collision between construction equipment, turnover accidents or the like in the site by incident and accident information, on the basis of statistical data related to construction site accidents occurred in the past according to operation of various construction equipment, receives risk information according thereto from its own database or outside, and reflects risk information in evaluation of the collective facility factors.

3. The method according to claim 1, wherein the general activity factors include information on a property of a performance task itself of each individual activity, past accident history, and categorized as indoor or outdoor accidents of each construction type and activity collected according to the construction type, the activity, and the workplace classified as indoor or outdoor, wherein risk information included for each individual construction type and activity, and information on mitigating activities for risk avoidance and/or mitigation are set according to a selected construction type, activity and workplace, and the special activity factors include a facility risk of a corresponding construction type and activity calculated by reflecting external environmental conditions and the facility factors in a selected construction type and activity, wherein
actual information including a state and a maintenance state of construction equipment, a current ground state of a construction site, a ground surface condition, a slope of the site, and a condition of surrounding areas is collected and reflected to reflect a correlation between an activity risk in a set region and the external environmental conditions.

4. The method according to claim 1, wherein at the activity PI calculation step, data of the PI result value is generated on a two-dimensional axis by reflecting past accident statistical information of each activity selected on the basis of past statistical information and external environmental condition information, and at the activity significance (S) reflecting step, an activity significance (S) for a risk of an individual activity itself is evaluated by a manager within a preset grade, an activity risk matrix is generated by drawing the PI result value and the activity significance (S) in three dimensions, and vector values of the activity risk matrix are calculated as the activity risk evaluation information.

5. The method according to claim 1, wherein the step of calculating activity risk evaluation information further includes, before the activity PI calculation step, an activity risk avoidance design step of presenting risk information included for each individual field worker and/or work organization, and information on mitigating activities for risk avoidance and/or mitigation according to a selected construction type, activity, and workplace.

6. The method according to claim 1, wherein at the step of calculating activity risk evaluation information, a facility comparison index is generated by relatively comparing information on average years of use, safety inspection cycles, and safety status of individual construction equipment deployed according to a construction type, activity, and workplace confirmed through reflection of the individual facility factors with information on average years of use, safety inspection cycles, and safety status of individual construction equipment actually deployed in the site, and the facility comparison index is presented as a numerical value at the activity significance (S) reflecting step so that a site manager may utilize the facility comparison index in increasing or decreasing possibility of an accident risk of actually deployed construction equipment or a risk of entire construction types and activities.

7. The method according to claim 1, wherein the step of calculating activity risk evaluation information further includes an activity risk notification step of generating a pop-up window or a separate additional icon for notification of a specific risk situation when it is evaluated that there is a risk accompanied with a specific construction type and/or a detailed activity, wherein
at the activity risk notification step, the pop-up window or the icon is displayed at a predetermined position in a multi-dimensional internal space of a multi-dimensional matrix or placed along axes of the multi-dimensional matrix, and provided to blink or in a set color to draw attention of a manager.

8. The method according to claim 1, wherein the step of calculating activity risk evaluation information further includes, before selection of a construction type, a step of separately calculating a partitioned regional risk index considering risk factors, such as at least one among a soil or ground condition, presence of existing structures, presence of underground deposits, presence of neighboring slopes, and surrounding construction environments for each partitioned region, which are probable to generate a disaster due to an external environment, wherein
the step of calculating a regional risk index includes the steps of:
setting an accident scenario for a partitioned region;
extracting risk factors of a plurality of regions on the basis of evaluation of a risk by a natural disaster such as strong wind, heavy rain or the like;
evaluating a damage risk of the plurality of regions on the basis of the extracted risk factors and the set accident scenario; and
calculating a regional risk index of the plurality of partitioned regions on the basis of the evaluated damage risk.

9. The method according to claim 1, wherein the general environmental factors include environmental information including at least one among geographic information, season, temperature, precipitation, and wind speed of a construction site collected according to the construction type, the activity, and the workplace, wherein a correlation with an environmental variable of each selected construction type and activity, and an environmental variable having a high environmental risk for at least one among a work and a duration are set on the basis of past statistical data, and the special environmental factors include real-time environmental information of a selected region where an activity is progressed as an environmental variable that affect a current performance task, wherein the environmental variable includes at least one among an altitude, a location, and a width of a region where the performance task is progressed, and is specifically differentiated and reflected.

10. The method according to claim 1, wherein at the environmental PI calculation step, data of the PI result value is generated on a two-dimensional axis by calculating an average value of environmental information for each section calculated through past statistical information, and reflecting past accident statistical information in a risk according to an average value of corresponding environmental information, and at the environmental significance (S) reflecting step, an environmental significance (S) for an environmental risk of a construction site itself is evaluated by a manager within a preset grade, an environmental risk matrix is generated by drawing the PI result value and the environmental significance (S) in three dimensions, and vector values of the environmental risk matrix are calculated as the environmental risk evaluation information.

11. The method according to claim 1, wherein the step of calculating environmental risk evaluation information further includes, before the environmental PI calculation step, an environmental risk avoidance design step of additionally presenting information on mitigating activities for risk avoidance and/or mitigation corresponding to weather and climate conditions according to a selected construction type, activity and workplace, in correspondence to risk information according to external environmental conditions directly or indirectly affecting each individual construction type and activity.

12. The method according to claim 1, wherein the step of calculating environmental risk evaluation information further includes an environmental risk notification step of generating a pop-up window or a separate additional icon for notification of a specific risk situation when it is evaluated that there is an external environmental risk directly or indirectly affecting a specific construction type and/or a detailed activity, wherein
at the environmental risk notification step, the pop-up window or the icon is displayed at a predetermined position in a multi-dimensional internal space of a multi-dimensional matrix or placed along axes of the multi-dimensional matrix, and provided to blink or in a set color to draw attention of a manager.

13. The method according to claim 1, wherein the step of calculating environmental risk evaluation information further includes, before selection of a construction type, a step of separately calculating a partitioned regional risk index considering risk factors, such as at least one among a soil or ground condition, presence of existing structures, presence of underground deposits, presence of neighboring slopes, and surrounding construction environments for each partitioned region, which are probable to generate a disaster due to an external environment, wherein
the step of calculating a regional risk index includes the steps of:
setting an accident scenario for a partitioned region;
extracting risk factors of a plurality of regions on the basis of evaluation of a risk by a natural disaster such as strong wind, heavy rain or the like;
evaluating a damage risk of the plurality of regions on the basis of the extracted risk factors and the set accident scenario; and
calculating a regional risk index of the plurality of partitioned regions on the basis of the evaluated damage risk.

14. The method according to claim 1, wherein the general worker factors includes categorized as indoor or outdoor properties of workers deployed in a predetermined performance task of each individual activity, the number of workers required for each performance task, a required work space, and equipment-related works by types of construction and activity selected according to a workplace classified as indoor or outdoor, and information on standard performance indexes according to a job skill of each job position and competency level is set according to the selected activity, and the special worker factors include, on the basis of an evaluation result of the worker competency evaluation step, information that requires individual consideration for individual workers participating in a unit activity, including at least one among a work environment, a workload, a labor time, body conditions, and possibility of occurrence of a state risk according to the environment, in a construction activity in which individual and/or organizational workers are deployed.

15. The method according to claim 1, wherein at the worker PI calculation step, data of a worker PI result value is generated on a two-dimensional axis by reflecting past accident statistical information of each activity selected on the basis of past statistical information and information on workers deployed in a performance task, and at the worker significance (S) reflecting step, a worker significance (S) for a risk of worker itself is evaluated by a manager within a preset grade, a worker risk matrix is generated by drawing the PI result value and the worker significance (S) in three dimensions, and vector values of the worker risk matrix are calculated as the worker risk evaluation information.

16. The method according to claim 1, wherein the worker competency evaluation step includes:
a personal competency evaluation step of calculating a personal competency index by evaluating personal competency; and
an organizational competency evaluation step of calculating an organizational competency index by evaluating organizational competency, wherein
the personal competency evaluation step calculates the personal competency index reflecting at least one among general personal information and special personal information of an individual using a physical competency index and a work competency index, and
the organizational competency evaluation step includes the steps of:
inputting and/or calculating deployed workers;
obtaining an arithmetic average of a competency index for the deployed workers;
reflecting activity environmental factors to reflect issues related to workers of an activity itself; and
calculating the organizational competency index.

17. The method according to claim 1, wherein the step of calculating worker risk evaluation information further includes, before the worker PI calculation step, a worker risk avoidance design step of presenting risk information included for each individual field worker and/or work organization, and information on mitigating activities for risk avoidance and/or mitigation according to a selected construction type, activity, and workplace.

18. The method according to claim 1, wherein at the step of calculating worker risk evaluation information, a worker comparison index is generated by relatively comparing information on an average experience and career, accident history, and body conditions of individual workers deployed according to a construction type, activity, and workplace confirmed through reflection of the individual worker factors with an average experience and career, accident history, and body conditions of individual workers actually deployed in a site, and the worker comparison index is presented as a numerical value at the worker significance (S) reflecting step so that a site manager may utilize the worker comparison index in increasing or decreasing possibility of an accident risk of actually deployed workers or a risk of entire construction types and activities.

19. The method according to claim 1, wherein the step of calculating worker risk evaluation information further includes a worker risk notification step of generating a pop-up window or a separate additional icon for notification of a specific risk situation when it is evaluated that there is a worker-related risk directly or indirectly affecting a specific construction type and/or a detailed activity, wherein
at the worker risk notification step, the pop-up window or the icon is displayed at a predetermined position in a multi-dimensional internal space of a multi-dimensional matrix or placed along axes of the multi-dimensional matrix, and provided to blink or in a set color to draw attention of a manager.

20. A multi-dimensional risk matrix generated by the method according to claim 1.
